(19) United States
(12) Patent Application Publication
(10) Pub. No.: US 2016/0029590 A1
(43) Pub. Date: Feb. 4, 2016

(54) Interactive Unit

(71) Applicant: BONDGY, INC., Spokane, WA (US)

(72) Inventors: Brooke Alicia Martin, Spokane, WA (US); Levi Robert Wilson, Spokane, WA (US); Robert Christopher Martin, Spokane, WA (US); Jeff Lynn Bendio, Spokane, WA (US); James Francis Pelland, Spokane, WA (US)

(21) Appl. No.: 14/777,369

(22) PCT Filed: Mar. 5, 2014
(86) PCT No.: PCT/US14/20907

§ 371 Date: Sep. 15, 2015

Related U.S. Application Data
(63) Continuation-in-part of application No. 13/843,622, filed on Mar. 15, 2013.

(51) Int. Cl. A01K 5/02; A01K 29/00; H04W 4/00; A01K 15/02

(52) U.S. Cl. CPC A01K 5/02; A01K 15/021; A01K 29/005; H04W 4/008

(57) ABSTRACT

The disclosure generally pertains to an interactive unit (IU) comprising a housing and a container. The IU can operate with at least one device enabling network connectivity. An end user device can connect to the IU to activate voice and/or video, and interact with the IU. A user can use the end user device to control the IU to dispense a treat, food, or product from the container. In at least one embodiment, a user will use the IU to connect with an animal located at the IU in order to communicate, bond, and train the animal.

### CROSS-REFERENCE TO RELATED APPLICATIONS

This application claims priority to and is a national phase application of International Application No. PCT/US14/20907 filed on Mar. 17, 2013, entitled “Interactive Unit,” which claims priority and is a continuation-in-part of U.S. patent application Ser. No. 13/843,622, filed Mar. 15, 2013, entitled “Interactive Unit”, hereby incorporated by reference in its entirety.

### BACKGROUND

Conventionally, people feed animals by placing food in a bowl, and allowing the animals to eat. Treats are typically dispensed in the same fashion, by standing in front of the animals and giving the treats to them. Alternatively, an animal owner can buy a timed delivery dispenser, and feed the animal at a certain time, whether the animal owner is present or not. However, when away from home, both owner and animal miss out on the interaction and the comforting, uplifting feeling of being together.

Animal owners have to be away from their animals for various reasons. Some for just a short time, and others for extended periods. Irrespective of the length of time, animal owners can feel an emptiness and sadness in being apart from their faithful, loving animals. Animals, in turn, get lonely, sad, and can be destructive when left alone for long periods of time.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a perspective view of an illustrative interactive unit.

FIG. 2 is a front view of the illustrative interactive unit of FIG. 1.

FIG. 3 is a top view of the illustrative interactive unit of FIG. 1.

FIG. 4 is a perspective view of some of the components of the interactive unit of FIG. 1.

FIG. 5 is an illustrative view of the interactive unit of FIG. 4 with a housing.

FIG. 6 illustrates an exemplary environment for the interactive unit.

FIG. 7 is a flow diagram that illustrates a process of an interactive unit in operation.

FIG. 8 is a flow diagram that illustrates the product delivery process of an interactive unit.

FIG. 9 to FIG. 13 are engineering drawings representing one particular embodiment of an internal component of an interactive unit as otherwise described herein. While specific dimensions are presented in FIG. 9 to FIG. 13, some embodiments of an internal component of an interactive unit as described herein have different dimensions.

FIG. 14 is a perspective view of alternative components of the interactive unit.

### DETAILED DESCRIPTION

This disclosure is directed, in part, to an interactive unit (IU) that facilitates communication, bonding, and training with an animal located away from a user. The uses described herein focus on the IU in the context of a human communicating with a pet. However, the IU can be implemented in various different environments including, but not limited to, homes, zoos, and hospitals. Because the focus of this description will be in the context of communicating with a pet, the product described herein will be a pet treat. Various embodiments of the IU, however, are not limited to dispensing a pet treat. Instead, in some embodiments the IU can be used to dispense many other products including, but not limited to, candy, food, medicine, money, and/or other objects.

The described IU device can allow the human and animal to connect, and quell remorseful feelings of separation. It can also remind the animal that he is not necessarily alone, and can discourage him from destructive behavior. The IU can also serve as a training tool. For example, the person interacting with the animal can have the animal do tricks and reward the animal with a treat.

In various embodiments, the IU includes a housing with at least one adjustable clamp on the outside. The adjustable clamp can be adjusted to accept a communications device. The communication device can include a video screen, a camera, a microphone, and a speaker. In some embodiments the communication device is a personal computing device, such as a telephone, a smart phone, a tablet computer, a hybrid computer, a docking tablet, a two-in-one device, a three-in-one device, a personal digital assistant, a television, a desktop computer, a laptop computer, or another similar device. According to techniques described herein, the communication device can be configured to automatically accept incoming calls from an end user device via a wireless and/or a cellular network. Once an incoming call is received, a streaming voice or video chat can be activated between the end user device and the communication device.

In some embodiments, the communication device can also be configured to communicate with a motor inside the housing via a communication system such as a wired and/or a wireless network, blue tooth, near field communication connection, wifi direct connection, or another communication system. In some embodiments, the motor can also be configured to accept a signal from the end user device directly via the wireless network. The end user device can enable the motor to activate a mechanism for pushing inside the housing through a direct connection to the motor. In various embodiments, the mechanism for pushing can be a turntable, a slide, a lever, or another dispensing apparatus. Additionally, in at least one embodiment, the motor can send an output signal to the end user device. The output signal can represent at least one performance measurement of the motor, the performance measurement including, but not limited to, a motor speed, a power draw, and a temperature.

Upon activation, the motor will guide a mechanism for pushing along a pre-determined path. The pre-determined path can transit through a container within the housing. The container can be preloaded with at least one unit of product or vessel. For example, pills, candy, money, and/or other objects may be arranged or contained in a vessel type unit of product to be delivered. For example, the vessel can include a closable dish (e.g., a petri type dish with a lid) that can be reused, and/or the vessel type unit of product can include a pre-sealed dish or packet suitable for one-time use. In some embodiments, the container is interchangeable, to allow for the IU to dispense products of various sizes and/or types. As the motor guides the mechanism for pushing along the pre-determined path, the turntable can cause the at least one unit of product to be dislodged from the container. The at least one unit of product can travel along a delivery passageway and exit the housing through a delivery opening, landing in a delivery tray. The animal can consume the at least one unit of product, and when viewed on the communication device, the user will get the emotional satisfaction of the connection with the animal. Additionally, the user can be comforted with the audio and/or visual communication with the animal, and can continue their day with a sense of peace.

The apparatuses, systems, and techniques described herein can be implemented in a number of ways. Example implementations are provided below with reference to the following figures.

### Illustrative Interactive Unit

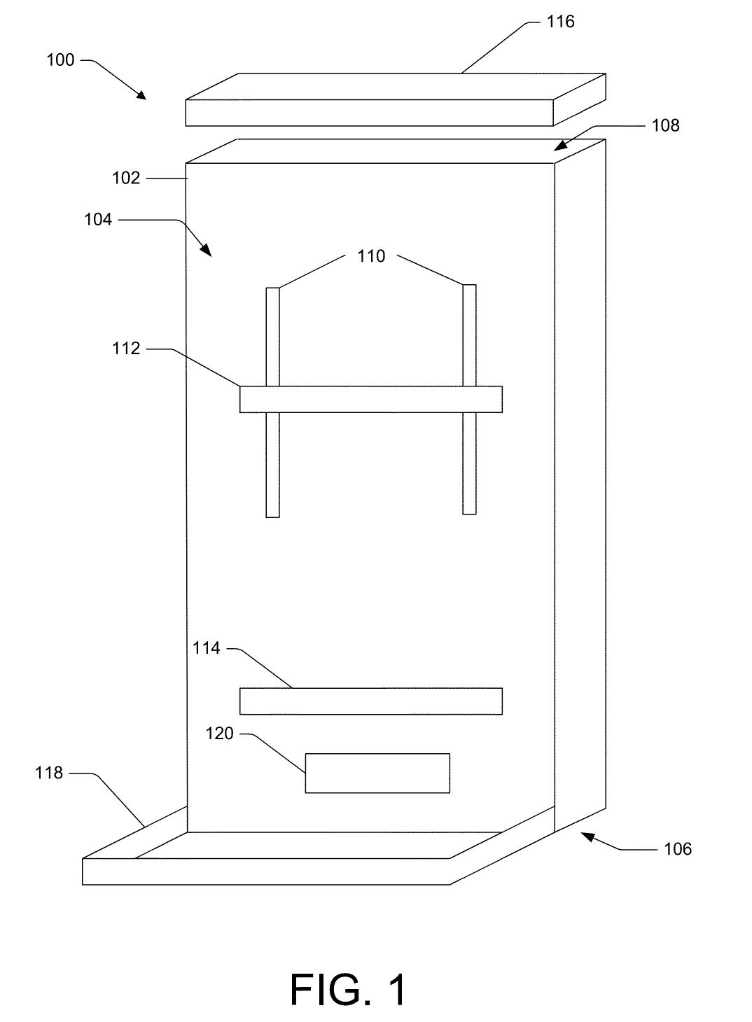

FIG. 1 is a perspective view of an illustrative interactive unit. The IU of FIG. 1 has a housing 102 with a plurality of vertical sides including a substantially flat side 104, as well as a bottom side 106, and a top side 108. The housing 102 can be constructed of overmolded plastic, vinyl, metal, or another impenetrable material. In some embodiments, the housing 102 can be constructed of a substantially translucent material, thereby allowing visibility of the internal components. In alternate embodiments, the housing 102 can be constructed of a substantially opaque material.

In at least one embodiment, the housing 102 is in a square shape. In other embodiments, the housing 102 can be rectangular, hexagonal, or another shape with at least one substantially flat side. In alternate embodiments, the housing 102 can be circular or ovular. The housing 102 can include at least one channel 110 on a substantially flat side 104, the at least one channel 110 being configured to guide at least one adjustable clamp 112. The at least one channel 110 can be configured vertically or horizontally on the substantially flat side 104. The at least one channel 110 is at least about one half of an inch to at most about eighteen inches in length. The adjustable clamp 112 can be adjustable along the at least one channel 110 throughout the length of the at least one channel 110. In some embodiments the adjustable clamp 112 can be secured in place along the at least one channel 110 by a fastening mechanism. The fastening mechanism can include, but is not limited to a screw, a bolt, a nut, a pin, a rubber band, and/or any other mechanism configured to secure a device. In some embodiments, two adjustable clamps 112 can be connected to each other via a tension mechanism such as a rubber band, a spring, or another tension mechanism affixed to the two adjustable clamps through at least two channels 110. The adjustable clamp 112 can be constructed of metal, plastic, or another stiff material.

In accordance with one or more embodiments, a housing 102 as depicted in FIG. 1 includes a second clamp, which in some instances is a cooperative adjustable clamp 112 and in other instances is a fixed clamp 114 as illustrated. The fixed clamp 114 can be configured substantially parallel to the adjustable clamp 112 on the substantially flat side 104. The fixed clamp 114 can operate in conjunction with the adjustable clamp 112 to hold a communication device. The fixed clamp 114 can be located at least about two inches from the at least one channel 110. The fixed clamp 114 can be constructed of metal, plastic, or another stiff material. The embodiment of FIG. 1 depicts a fixed clamp 114 located underneath the adjustable clamp 112, both being substantially perpendicular to the vertical axis of the housing 102. In another embodiment, the fixed clamp 114 can be above the adjustable clamp 112. In yet another embodiment, the fixed clamp 114 and the adjustable clamp 112 can be configured substantially parallel to the vertical axis of the housing 102. In the embodiment with the fixed clamp 114 and the adjustable clamp 112 being substantially parallel to the vertical axis of the housing 102, the fixed clamp 114 can be located to the right of the adjustable clamp 112, or vice-versa.

In some embodiments, the communication device can be seated in between the adjustable clamp 112 and the fixed clamp 114. The communication device can include a camera, a screen, a microphone, and a speaker. The communication device can be configured to connect to a communication system such as a wired and/or a wireless network. The communication device can also be configured to accept and send signals via blue tooth, near field communications, wifi direct, or another similar technology. The communication device can be a personal computing device, such as a telephone, a smart phone, a tablet computer, a hybrid computer, a docking tablet, a two-in-one device, a three-in-one device, a personal digital assistant, a television, a desktop computer, a laptop computer, or similar device capable of wireless connectivity. The communication device can be at least about 1 inch by 1 inch and at most about 12 inches by 12 inches in dimension.

In various embodiments, the IU of FIG. 1 includes a cap 116 configured to fit on the top side 108. In some instances the cap 116 can be attached to the housing 102 via a hinge, a strap, or another connection. The cap 116 can be constructed of overmolded plastic, vinyl, metal, or another impenetrable material. In some embodiments, the cap 116 can be constructed of a substantially translucent material, thereby allowing visibility of the internal components. In alternate embodiments, the cap 116 can be constructed of a substantially opaque material.

The IU of FIG. 1 can also include a delivery tray 118, coupled to the bottom side 106. The delivery tray 118 can be the same size as the bottom side 106, or can be bigger. In another embodiment, the delivery tray 118 can be smaller than the bottom side 106. The delivery tray 118 can be made of metal, plastic, or another material which is substantially stiff. The delivery tray 118 can be configured to accept a treat dispensed via a delivery opening 120. The delivery opening 120 may include a door. For example, the delivery opening 120 may include a swinging door pivotably coupled to the housing 102.

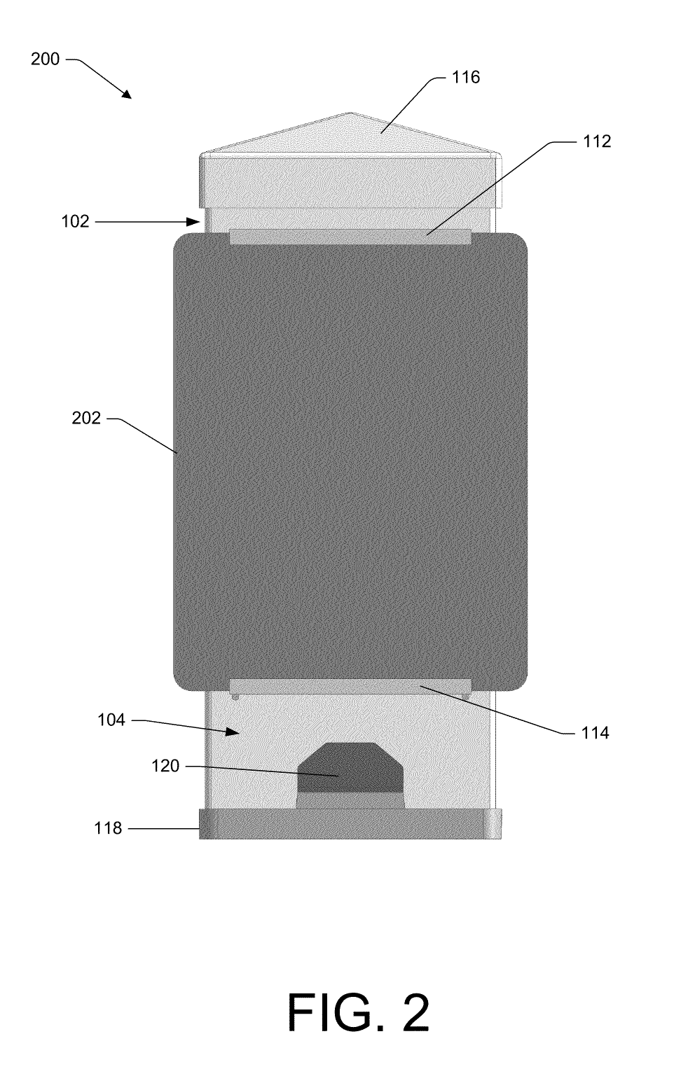

FIG. 2 is a front view of another embodiment of the illustrative interactive unit of FIG. 1. Device 200, as depicted in FIG. 2, unless otherwise described includes parts consistent with those described regarding device 100 of FIG. 1.

In some embodiments, the device 200 includes a communication device 202. In other embodiments, the communication device 202 is physically separate and apart from the device 100 or 200, which can operate with various communication devices 202. The communication device 202 can be seated between the two clamps. For instance, the two clamps can be the adjustable clamp 112 and the fixed clamp 114. The communication device 202 can include a camera, a screen, a microphone, and a speaker. The communication device 202 can be configured to connect to a wired and/or a wireless network. The communication device 202 can also be configured to accept and send signals via blue tooth, near field communications, wifi direct, or another similar technology.

The communication device 202 can be a personal computing device, such as a telephone, a smart phone, a tablet computer, a hybrid computer, a docking tablet, a two-in-one device, a three-in-one device, a personal digital assistant, a television, a desktop computer, a laptop computer, or similar device capable of wireless connectivity. The communication device 202 can be removable and replaceable. For example, a user can seat a communication device 202 between the adjustable clamp 112 and the fixed clamp 114. In another example, a user can place a communication device 202 proximate to the device 200. For example, a user can place the communication device 202 adjacent to the device 200 (e.g., on a table, on a window ledge, on a floor, on a chair, etc.) and activate a streaming voice or video chat between the end user device and the communication device 202. While at a remote location, the user can communicate through the communication device 202 seated between the clamps on the IU. Once back in the same location with the IU, however, the user can unseat the communication device 202 from the clamps on the IU, and use the communication device 202 for a different purpose.

In various embodiments, the communication device 202 includes a software application. The software application can enable the communication device 202 to receive an incoming signal. Responsive to the incoming signal, the communication device 202 provides an indication of the incoming signal and activates a call connection. In some embodiments, the software application can also enable the communication device to send an activation signal to a motor located within the housing 102. For example, an end user device can initiate a call via a signal to the communication device 202 from a remote location. After the communication device activates the call connection, the end user device can transmit voice and/or video over a wireless connection for presentation via the microphone and screen of the communication device. In an example use case, the end user device can initiate a call via a signal to the communication device 202, and the user at the end user device can say the name of their pet, and give the pet commands through the functionality of the communication device 202.

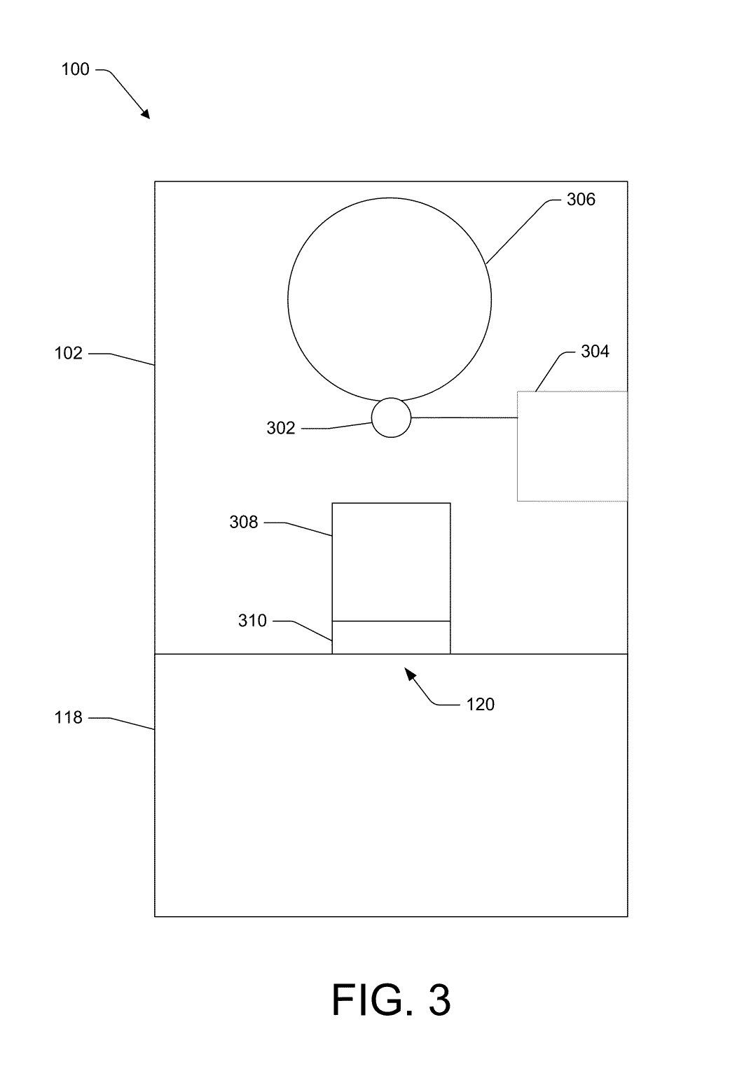

FIG. 3 is a top view of an illustrative interactive unit as described regarding FIG. 1. FIG. 3 shows several interior components of an IU after the cap is removed.

In some embodiments, a motor 302 is an electric motor. The motor can be a servo motor, a rotary motor, a coreless motor, or another electric motor. As illustrated, the motor can be coupled to a power source 304. The motor is configured to receive an input signal from a communication device, such as communication device 202. Additionally, the motor can be configured to send an output signal. The motor can send and receive the input signal and the output signal via a communication system such as a wired and/or a wireless connection. The input signal and the output signal can be transmitted via a wire, a wireless network, a blue tooth connection, a near field communication connection, or a wifi direct connection. The input signal and the output signal can be processed through a microcontroller unit, such as an Arduino microcontroller, or another microcontroller capable of processing the input signal and the output signal.

In some embodiments, the motor can send the output signal to a communication device such as communication device 202, or to an end user device. The output signal can include information including, but not limited to, the working status of the motor. For example, if the motor does not operate effectively after receiving an input signal, the motor can send the output signal to the communication device to alert of the error.

In various embodiments, the motor 302 is operatively coupled to a mechanism for pushing 306. The mechanism for pushing 306 can include a turntable, push-rod, or push-plate, or another suitable mechanism. The input signal can activate the motor 302, thereby activating the mechanism for pushing 306.

In various embodiments, the motor 302 activates the mechanism for pushing 306, causing the mechanism for pushing 306 to track along a plane. While tracking along the plane, the mechanism for pushing 306 travels along a pre-determined path through an opening in a container 308. While traveling along the pre-determined path through the container 308, the mechanism for pushing 306 can contact at least one unit of a plurality of units of product located within the container 308. After contact with the plurality of units of product, the mechanism for pushing 306 continues along the pre-determined path, applying pressure to the at least one unit of product. The mechanism for pushing 306 thus forces the at least one unit of product through a hole in the container 308, and into a delivery passageway 310.

In some embodiments, the delivery passageway 310 such as a chute, can have a coefficient of friction of at least about 0.05 and at most about 0.5, in order to control the speed of delivery of the at least one unit of product. The at least one unit of product can travel through the delivery passageway 310 and exit the housing 102 through a delivery opening such as delivery opening 120. After exiting the delivery opening, the at least one unit of product can come to rest in a delivery tray such as delivery tray 118. Once outside of the housing 102, a receiver can access the at least one unit of product.

For example, a user can use an end user device to initiate a call via a signal to the communication device to contact a pet. The user can give the pet commands through the functionality of the communication device. The user can also reward the pet by sending an input signal from the end user device to the motor 302, which can cause a treat to be dispensed. In various embodiments, the input signal can be sent from the end user device either directly to the motor 302, or through a communication device such as communication device 202. Once the user sends the input signal to the motor 302, the motor 302 can activate the mechanism for pushing 306 and push a treat from the container 308, through the delivery passageway 310, out the delivery opening, and into the delivery tray. After the treat exits the delivery opening, the pet can consume the treat.

In other examples, a user can use an end user device to initiate a call via a signal to the communication device to contact a person. The user can communicate with the person through the functionality of the communication device and can cause the input signal to be sent to the motor 302 to use the IU to dispense a unit of product including pills, candy, money, and/or other objects for the person. For example, pills, candy, money, and/or other objects may be arranged or contained in a vessel type unit of product to be delivered. For example, the vessel type unit of product can include a closable dish (e.g., a petri type dish with a lid) that can be reused, and/or the vessel type unit of product can include a pre-sealed dish or packet suitable for one-time use. In various embodiments, the input signal can be sent from the end user device either directly to the motor 302, or through a communication device such as communication device 202. Thus the motor 302 can activate the mechanism for pushing 306 and push the vessel type unit of product holding one or more pills (e.g., tablets, capsules, caplets, etc.), candy, money, and/or other objects from the container 308, through the delivery passageway 310, out the delivery opening, and into the delivery tray. After the vessel type unit of product exits the delivery opening, the person can open the vessel type unit of product consume the one or more pills or candy, or access the money, and/or other objects contained therein. The IU device can allow the user and the person to connect, and provide comfort.

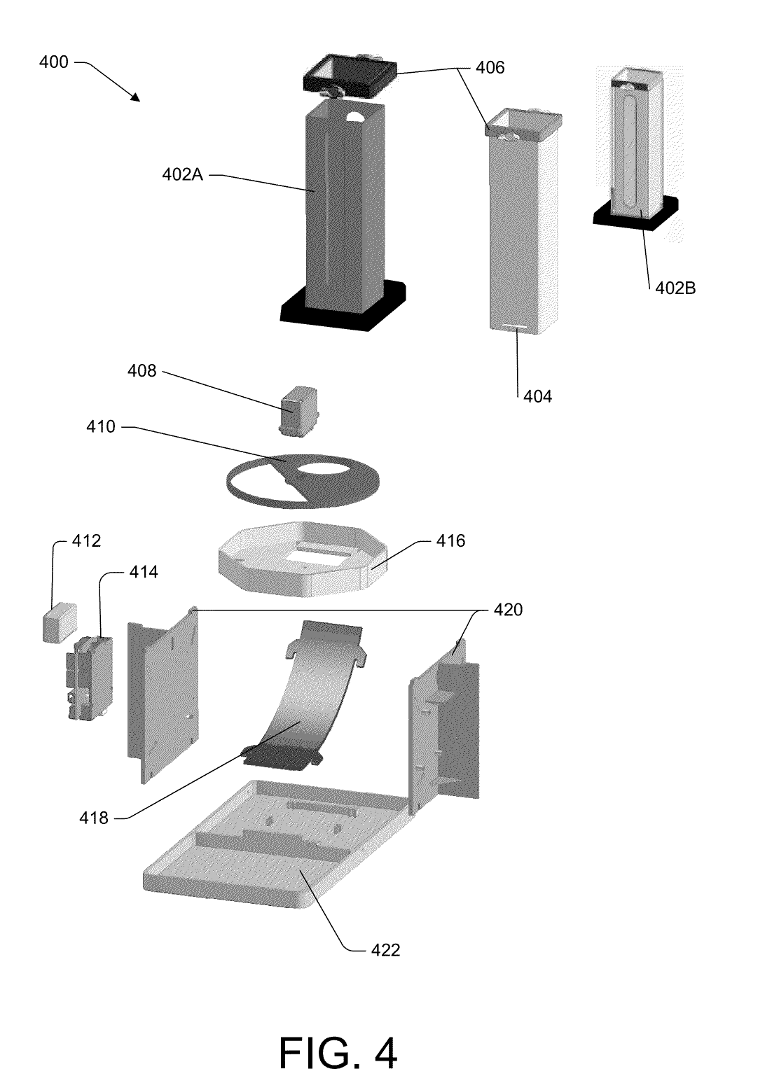

FIG. 4 is a perspective view of the components of the interactive unit of FIG. 1, FIG. 2 and/or FIG. 3. The components 400 as shown in FIG. 4, can include a container 402, which can be connected to a housing such as housing 102. The container 402 is configured to accept at least one unit of product. In some embodiments, the container 402 is an interchangeable container 402A, wherein the container 402A can be removed and replaced by another container 402B of a different size or containing additional or alternate product. In some embodiments, the container 402 can be removed in order to refill the container 402 with at least one unit of product. The container can also be refilled while still connected to the IU.

In various embodiments, the user can remove the container 402 and replace it with a container 402 of a different size or containing additional or alternate product. This will allow the user to vary the function of the IU, or change the size of a unit of the product. For example, if the IU is used for a big dog that ingests big treats, the interchangeable container can be configured to take big biscuits. However, if the user wants to change the size of treat for a small dog, the user can remove the interchangeable container sized for big treats, and replace it with a second container, the second container being configured to take at least one unit of product of a relatively smaller size, or vice versa.

In some embodiments, the container 402 can be affixed within the housing, so that it is not removable. In embodiments with the container 402 affixed, the container 402 can be refilled via a first replaceable sleeve 404. The first replaceable sleeve 404 can be sized to fit within the container 402, and can contain a plurality of units of product. In some embodiments, the container 402 can contain a securing clamp 406. In other embodiments, the securing clamp 406 can be affixed to the first replaceable sleeve 404.

In various embodiments, a first replaceable sleeve 404 can be removable from container 402 and reloadable with a plurality of units of product. In another embodiment, the first replaceable sleeve 404 can be removed from container 402 and replaced with a second replaceable sleeve 404. The second replaceable sleeve 404 can be configured to hold a plurality of units of product. In some embodiments, the second replaceable sleeve 404 can be configured to hold a plurality of units of product of a different size than the product held by the first replaceable sleeve 404. In such embodiments, the exterior of the second replaceable sleeve 404 can be configured to be the same size as the first replaceable sleeve 404, however the interior can be a different size to hold the plurality of units of product of a different size.

The IU of FIG. 4 can include a motor 408. In various embodiments, the motor 408 is located next to the container 402. In other embodiments, it can be located at a distance from the container 402. The motor 408 can be operatively coupled to a mechanism for pushing 410. The mechanism for pushing 408 can include a turntable, push-rod, or push-plate, or another suitable mechanism.

In some embodiments, the motor 408 is an electric motor. The motor 408 can be a servo motor, a rotary motor, a coreless motor, or another electric motor. In various embodiments, the motor 408 can be coupled to a power source 412. The motor is configured to receive an input signal from a communication device, such as communication device 202. Additionally, the motor can be configured to send an output signal. The motor can send and receive the input signal and the output signal via a communication system such as a wired and/or a wireless connection. The input signal and the output signal can be transmitted via a wire, a wireless network, a blue tooth connection, a near field communication connection, or a wifi direct connection. The input signal and the output signal can be processed through a microcontroller unit 414, such as an Arduino microcontroller, or another microcontroller capable of processing the input signal and the output signal.

In various embodiments, the motor 408 receives an input signal from the communication device via the microcontroller unit 414, and activates the mechanism for pushing 410, causing the mechanism for pushing 410 to track along a plane. While tracking along the plane, the mechanism for pushing 410 travels along a pre-determined path through an opening in container 402. While traveling along the pre-determined path through the container 402, the mechanism for pushing 410 can contact at least one unit of product located within the container 402. After contact with the at least one unit of product, the mechanism for pushing 410 continues along the pre-determined path, continually applying pressure on the at least one unit of product. The mechanism for pushing 410 thus forces the at least one unit of product through a hole in the container 402, through a support plate 416, and into a delivery passageway 418. In various embodiments, the delivery passageway 418 can be a chute, a slide, a channel, or another delivery path. In at least one embodiment, the delivery passageway 418 is seated in a support wall 420 within a housing such as housing 102.

In some embodiments, the container 402 is seated on top of the mechanism for pushing 410. In such embodiments, the motor 408 activates the mechanism for pushing 410, causing it to track along a pre-determined path along the bottom side of container 402. As the mechanism for pushing tracks along the pre-determined path, the hole in the container 402, a hole in the mechanism for pushing 410, and a hole in the support plate 416 align to allow at least one unit of product to exit the container 402 and enter the delivery passageway 418.

In various embodiments, the delivery passageway 418 can be constructed out of metal, plastic, acrylic, or another material capable of being molded. A delivery passageway 418 such as a chute can also include a coating on an interior passageway to create a coefficient of friction of at least about 0.1 and at most about 0.5. The coating can enable the delivery passageway 418 to change the speed of the one unit of a plurality of product as it traverses the delivery passageway 418, to insure the one unit of a plurality of product exits the delivery opening at a relatively acceptable rate.

The at least one unit of product can travel through the delivery passageway 418 and exit the IU through the delivery opening. The at least one unit of product can then be available for consumption by a receiver. For example, a dog can sit in front of the IU and await a treat. After the treat is dispensed out of the delivery opening, the dog can consume it.

In some embodiments, the components 400 include a delivery tray 422. The delivery tray 422 can be the same size as the housing such as housing 102 in at least one dimension, and can be larger or smaller in another. In at least one embodiment, the delivery tray 422 extends beyond the delivery opening. The delivery tray 422 can be made of metal, plastic, or another material which is substantially stiff. The delivery tray 422 can be configured to accept a treat dispensed via the delivery opening.

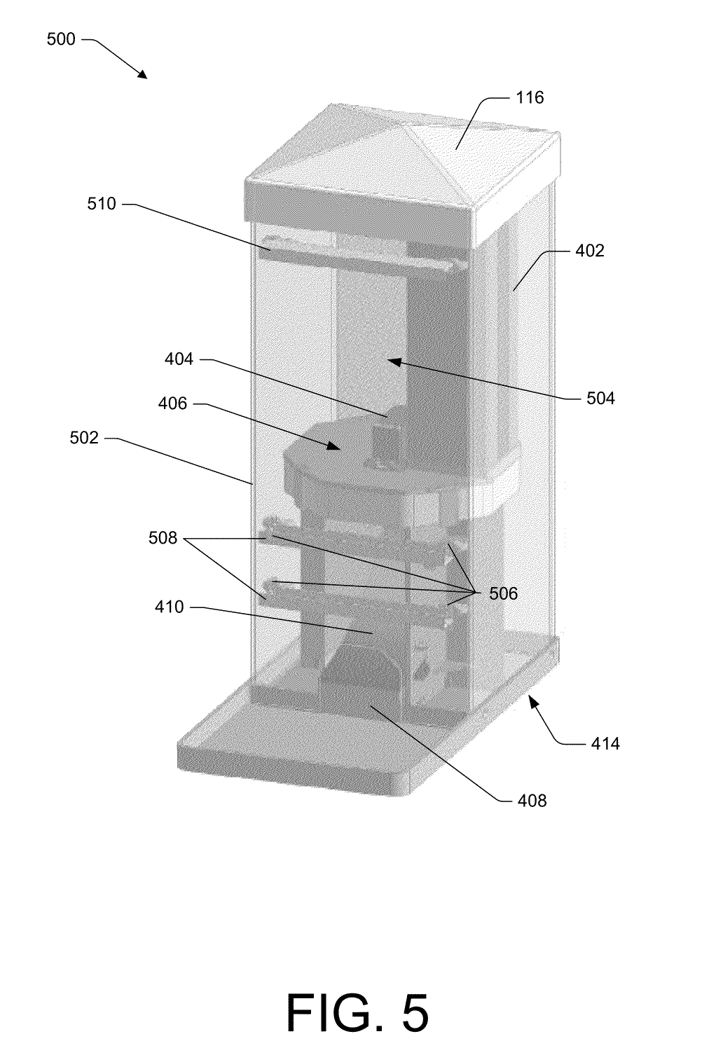

FIG. 5 is an illustrative view of the components of an interactive unit as described regarding FIG. 4 including a housing.

A device 500, as shown in FIG. 5, can include a housing 502 consistent with housing 102 as described above. In various embodiments, the housing 502 surrounds a plurality of internal components consistent with components as described in device 400. The housing 502 can have a plurality of vertical sides, which in some instances includes at least one substantially flat side 504. The housing 502 can be constructed of overmolded plastic, vinyl, metal, or another impenetrable material. As illustrated in device 500, the housing 502 can be constructed of a substantially translucent material, thereby allowing visibility of the internal components. In alternate embodiments, the housing 502 can be constructed of a substantially opaque material.

In at least one embodiment, the housing 502 is in a square shape. In other embodiments, the housing 502 can be rectangular, hexagonal, or another shape with at least one substantially flat side. In alternate embodiments, the housing may be circular or ovular. The housing 502 can include at least one channel on a substantially flat side 504, the at least one channel 506 being configured to guide adjustable first clamp 508. The at least one channel 506 can be configured vertically or horizontally on the substantially flat side 504. The at least one channel 506 is at least about two inches to at most about eighteen inches in length. The first clamp 508 can be adjustable along the at least one channel 506 throughout the length of the at least one channel 506. In some embodiments, the first clamp 508 can be secured in place along the at least one channel 506 by a fastening mechanism. The fastening mechanism can include, but is not limited to a screw, a bolt, a nut, a pin, a rubber band, and/or any other mechanism configured to secure a device. In some embodiments, two adjustable clamps 508 can be connected to each other via a tension mechanism such as a rubber band, a spring, or another tension mechanism affixed to the two adjustable clamps through at least two channels 506. The first clamp 508 can be constructed of metal, plastic, or another stiff material.

In accordance with one or more embodiments, the housing 502 depicted in FIG. 5 can also include a second clamp 510, which in some instances is a cooperative adjustable clamp and in other instances is a fixed clamp as illustrated. The second clamp 510 can be configured substantially parallel to the first clamp 508 on the substantially flat side 504. The second clamp 510 can operate in conjunction with the first clamp 508 to hold a communication device. The second clamp 510 can be located at least about two inches from the at least one channel 506. The second clamp 510 can be constructed of metal, plastic, or another stiff material. The embodiment of FIG. 5 depicts the second clamp 510 located above the first clamp 508, both being substantially perpendicular to the vertical axis of the housing 502. In another embodiment, the second clamp 510 can be underneath the first clamp 508. In yet another embodiment, the second clamp 510 and the first clamp 508 can be configured substantially parallel to the vertical axis of the housing 502. In the embodiment with the second clamp 510 and the fixed clamp 508 being substantially parallel to the vertical axis of the housing 502, the second clamp 510 can be located to the right of the first clamp 508, or vice-versa.

In some embodiments, the communication device can be seated in between the first clamp 508 and the second clamp 510. The communication device can include a camera, a screen, a microphone, and a speaker. The communication device can be configured to connect to a wireless network. The communication device can also be configured to accept and send signals via blue tooth, near field communications, wifi direct, or another similar technology.

The communication device can be a personal computing device, such as a telephone, a smart phone, a tablet computer, a hybrid computer, a docking tablet, a two-in-one device, a three-in-one device, a personal digital assistant, a television, a desktop computer, a laptop computer, or similar device capable of wireless connectivity. The communication device can be removable and replaceable. For example, a user can place a tablet between the first clamp 508 and the second clamp 510. While at a remote location, the user can communicate through the tablet on the IU. Once back in the same location with the IU, however, the user can remove the communication device from the IU, and use it for a different purpose.

In various embodiments, the IU of FIG. 5 includes a cap 116 configured to fit on the top of the housing 502. In some instances the cap can be attached to the housing 502 via a hinge, a strap, or another connection. The cap 116 can be constructed of overmolded plastic, vinyl, metal, or another impenetrable material. In some embodiments, the cap 116 can be constructed of a substantially translucent material, thereby allowing visibility of the internal components through the cap 116. In alternate embodiments, the cap 116 can be constructed of a substantially opaque material.

### Illustrative Environment

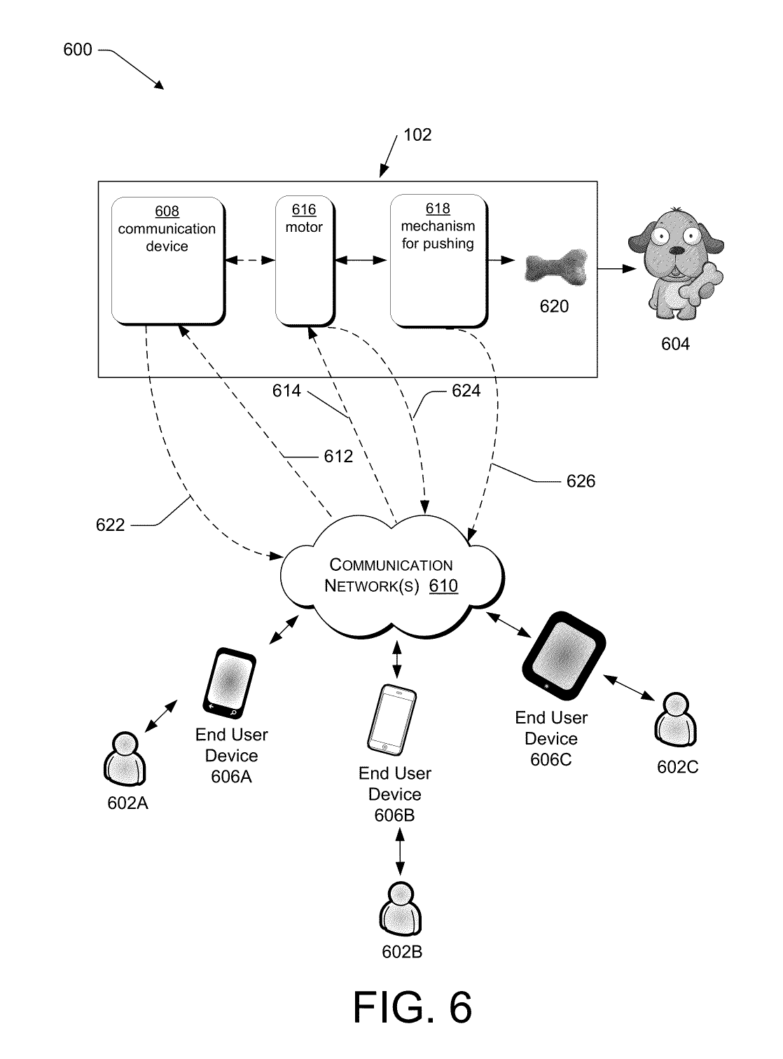

FIG. 6 illustrates an example environment for interactive units as described in FIGS. 1-5. As shown in environment 600, a user 602 located at a remote location can begin the interaction with a receiver 604 via an end user device 606. In some embodiments, multiple users 602A, 602B, and 602C can interact with the receiver 604 via multiple end user devices 606A, 606B, and 606C, respectively. In the illustrative embodiment, an end user device 606 can call a communication device 608 using a communication network 610 including, but not limited to a broadband network, a wireless network, a wide area network (WAN), a local area network (LAN), and an Internet. The end user device 606 can be a personal computing device, such as a telephone, a smart phone, a tablet computer, a hybrid computer, a docking tablet, a two-in-one device, a three-in-one device, a personal digital assistant, a television, a desktop computer, a laptop computer, or another device configured for the communication network 610. The communication device 608 can be a personal computing device, such as a telephone, a smart phone, a tablet computer, a hybrid computer, a docking tablet, a two-in-one device, a three-in-one device, a personal digital assistant, a television, a desktop computer, a laptop computer, or another device configured for the communication network 610.

In various embodiments, the end user device 606 contacts the communication device 608 such as via signal path 612. Upon contact, the end user device 606 transmits voice and/or video to the communication device 608 such as via signal path 612 for presentation such as to the receiver 604 through communication device 608. In some embodiments, the end user device 606 can also transmit a first activation signal via signal path 614 to a motor 616.

In some embodiments, an end user device 606 can send a second activation signal via signal path 612 to the communication device 608, the communication device 608 being operatively coupled to the motor 616. The communication device 608 can be operatively coupled to the motor 616 via a communication system such as a wired and/or a wireless connection. The wired and/or wireless connection permits a signal to be transmitted via wire, network, blue tooth connection, near field communication connection, or wifi direct connection. In such embodiments, the second activation signal can cause the motor 616 to be activated.

In various embodiments, the motor 616 is operatively coupled to a mechanism for pushing 618. The mechanism for pushing 618 can include a turntable, push-rod, or push-plate, or another suitable mechanism. The mechanism for pushing 618 can be configured to receive an input signal from the motor 616.

In various embodiments, the motor 616 activates the mechanism for pushing 618, causing the mechanism for pushing 618 to track along a plane. While tracking along the plane, the mechanism for pushing 618 travels along a pre-determined path through an opening in the container. While traveling along the pre-determined path through the container, the mechanism for pushing 618 can contact at least one unit of a plurality of product 620 located within the container. After contact with the at least one unit of the plurality of product 620, the mechanism for pushing 618 continues along the pre-determined path, applying pressure to the at least one unit of product 620. The mechanism for pushing 618 thus forces the at least one unit of product 620 through a hole in the container, and into a delivery passageway.

The at least one unit of a product 620, once dislodged from the container, exits the container and enters the delivery passageway. The delivery passageway can be constructed of metal, acrylic, plastic, or another material that is substantially stiff. In various embodiments, the delivery passageway can be a chute, a slide, a channel, or another delivery path. The at least one unit of product 620 glides through the delivery passageway and can exit the housing through a delivery opening. After the at least one unit of product 620 exits the housing, the receiver 604 can access it. For example, if the at least one unit of product 620 is a dog treat, the receiver 604 can eat the dog treat. The user 602 located at a remote location can watch the receiver 604 eat the dog treat through a video signal sent from the communication device 608 to the end user device 606. Both user 602 and receiver 604 can feel at ease that the other is still in contact, and still able to provide some affection or execute some training while located apart from each other.

In various embodiments, the communication device 608 is configured to send a first output signal 622 to the end user device 606. The first output signal 622 can contain information including, but not limited to an activation signal and a power remaining indication. Additionally, the motor 616 can be configured to send a second output signal 624 to the end user device 606. The second output signal 624 can contain information including, but not limited to a motor activation signal. In some instances the first output signal 622 and the second output signal 624 can cause a notification to be displayed on end user device 606A, 606B, and/or 606C. In some embodiments the first output signal 622 and the second output signal 624 can block end user devices 606A, 606B, and/or 606C from sending the first activation signal via signal path 614 and the second activation signal via signal path 612 within a pre-determined period of time.

In some embodiments, the mechanism for pushing 618 is configured to send a signal 626 to display a message on end user device 606A, 606B, and/or 606C. The message 626 can include an error report, indicating that the motor 614 and/or the mechanism for pushing 618 did not function properly. In some instances such a message can be sent to end user devices 606A, 606B, and/or 606C via the paths of output signals 622 and/or 624.

### Illustrative Processes

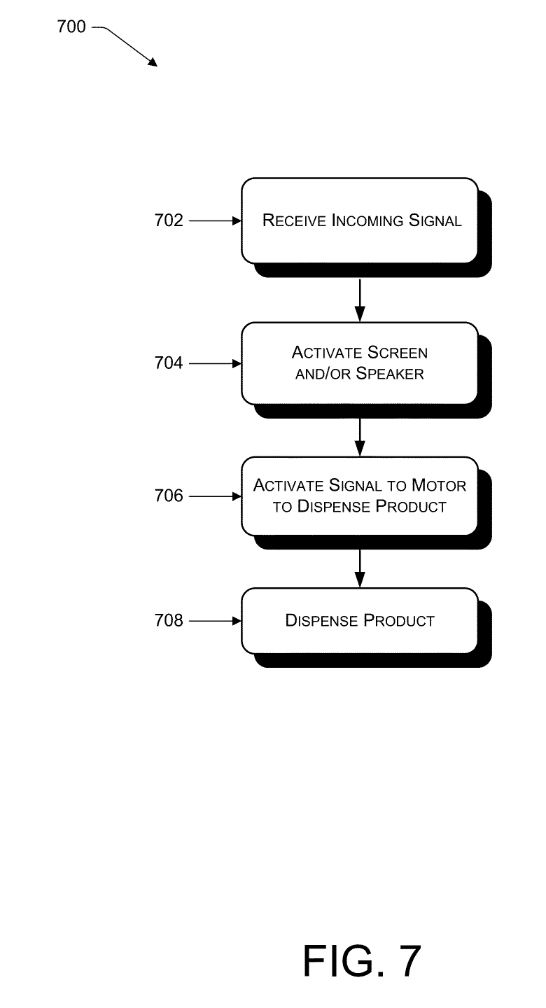

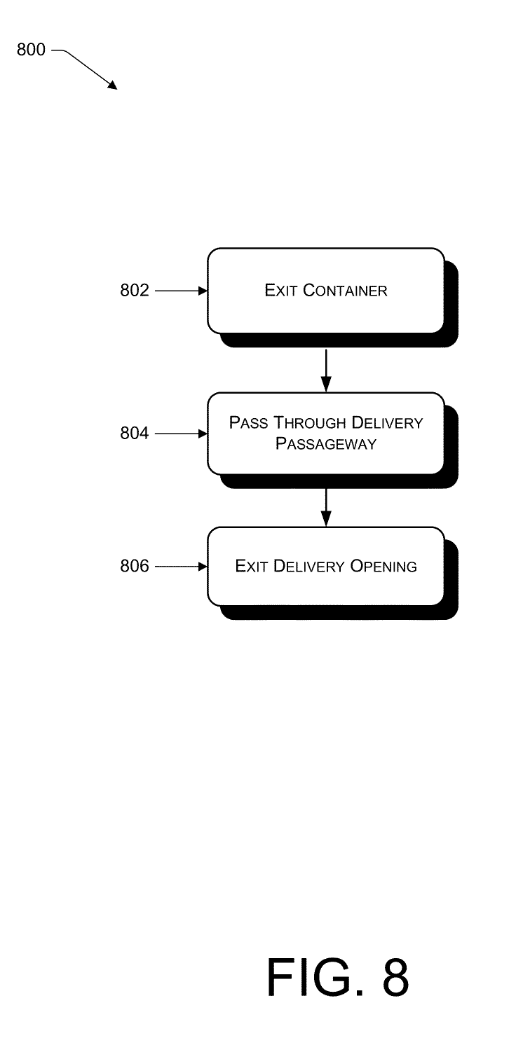

FIGS. 7 and 8 are flow diagrams that illustrate a process 700 and 800 for using an interactive unit as described regarding FIGS. 1-6 above. The operations of an example process are illustrated in individual blocks and summarized with reference to those blocks. The process is illustrated as a logical flow of blocks, each block of which can represent one or more operations that can be implemented in hardware, software, or a combination thereof. In the context of software, the operations represent computer-executable instructions stored on one or more computer-readable storage media that, when executed by one or more processors, enable the one or more processors to perform the recited operations. Generally, computer-executable instructions include routines, programs, objects, modules, components, data structures, and the like that perform particular functions or implement particular abstract data types. Note that the order in which the processes are described is not intended to be construed as a limitation, and any number of the described operations can be executed in any order, combined in any order, subdivided into multiple sub-operations, and/or executed in parallel to implement the described process. Additionally, individual blocks may be deleted from the processes without departing from the spirit and scope of the subject matter described herein.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions. As previously discussed, an end user device such as end user device 606 can activate an IU by sending a signal to a first communication device such as communication device 202 and/or 608, the first communication device affixed to the IU. In other embodiments, the first communication device is physically separate and apart from the IU. In some embodiments the first communication device is a personal computing device, such as a telephone, a smart phone, a tablet computer, a hybrid computer, a docking tablet, a two-in-one device, a three-in-one device, a personal digital assistant, a television, a desktop computer, a laptop computer, or another similar device. As shown in FIG. 7 in process 700 at 702, the first communication device receives an incoming signal. The incoming signal may be from any one of a plurality of end user devices such as end user devices 606A, 606B and 606C. At 704, responsive to receiving the incoming signal, the first communication device can activate a screen and/or a speaker via a wireless connection. In some instances, for example, voice can be transmitted through a speaker located in the first communication device, and video can be displayed on a screen located in the first communication device. In other embodiments, the speaker and/or the screen can be separate from the first communication device. In some instances, the speaker and/or the screen can be incorporated into a housing such as housing 102.

At 706, a second signal from the end user device activates the motor to dispense at least one unit of product. In some embodiments, the first communication device and the end user device can be loaded with a software application. The software application can enable the end user device to send the second signal directly to a motor via a communication network including, but not limited to a broadband network, a wireless network, a WAN, a LAN, and an Internet. In various embodiments the software application can enable the end user device to send a signal to the first communication device via a communication network causing the first communication device to send a signal to a motor.

At 708, responsive to receiving the signal from 706, the motor can activate a mechanism for pushing to selectively dispense at least one unit of product. Consistent with the discussion above, the mechanism for pushing can include a turntable, a push-rod, a push-plate, or another suitable mechanism.

In various embodiments, the motor guides the mechanism for pushing along a pre-determined path through a container, the container configured to house at least one unit of product. As the mechanism for pushing travels along the pre-determined path, the mechanism for pushing selectively pushes at least one unit of product from the container and into a delivery passageway, thereby dispensing the at least one unit of product.

As shown in FIG. 8 in process 800 at 802, the at least one unit of product exits a container. In various embodiments, the at least one unit of product can be forced out of the container by a mechanism for pushing such as mechanism for pushing 306. At 802, the at least one product can enter a delivery passageway such as delivery passageway 310. In various embodiments, the delivery passageway is adjacent to the container. At 804, the at least one unit of product travels through the delivery passageway toward a delivery opening. The delivery passageway can be constructed of metal, plastic, acrylic, or another substantially stiff material. In some embodiments, the delivery passageway 310 such as a chute can have a coefficient of friction of at least about 0.1 and at most about 0.5, in order to control the speed of delivery of the at least one unit of product.

At 806, the at least one unit of product exits the housing through the delivery opening. After passing through the delivery opening, the at least one unit of product can come to rest in a delivery tray. Once the at least one unit of product is in close proximity of the delivery tray, a receiver can access the at least one unit of product. For example, the user can activate the process while a dog sits in front of the IU. The dog can see or smell the treat after exiting via the delivery opening. The dog can then consume the treat, and be rewarded for communication with the user, which can give a feeling of satisfaction to both dog and user.

### Engineering Drawings

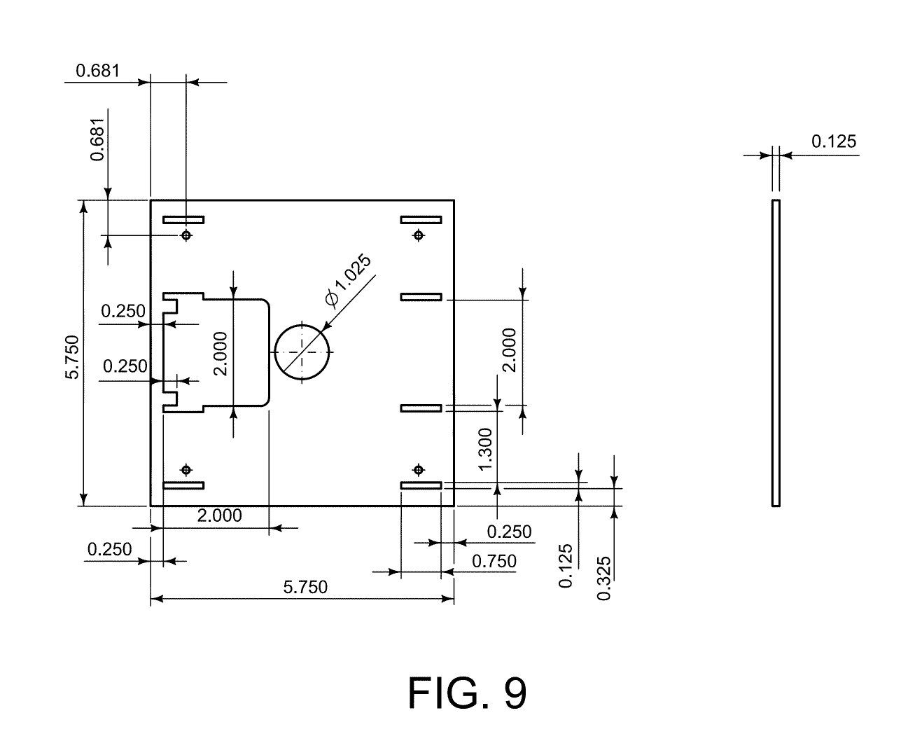

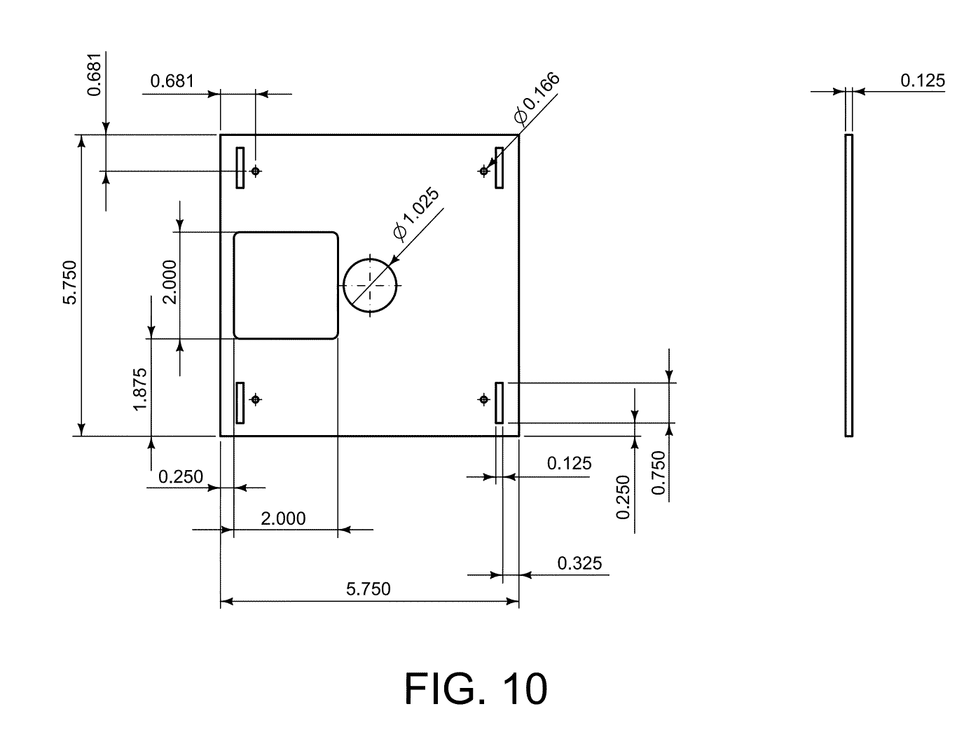

FIGS. 9 and 10 are engineering drawings representing a top view of an illustrative interactive unit of at least one particular embodiment. FIGS. 9 and 10 show several interior components of particular embodiments of an IU after the cap is removed.

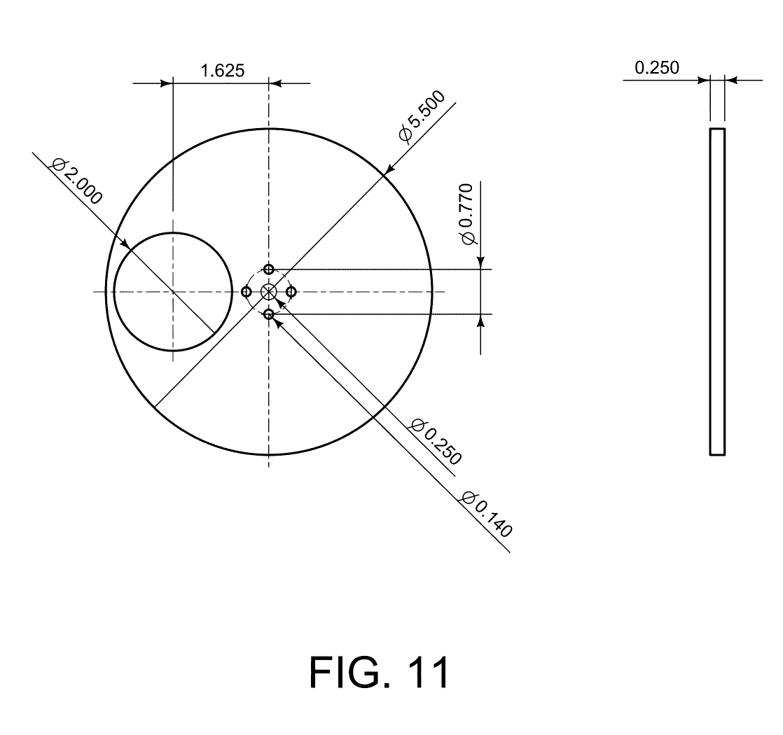

FIG. 11 is an engineering drawing representing a particular embodiment of a mechanism for pushing such as mechanism for pushing 306. In this particular embodiment, the mechanism for pushing is a turntable. In another embodiment, the mechanism for pushing may be a push-rod, a push-plate, or another suitable mechanism.

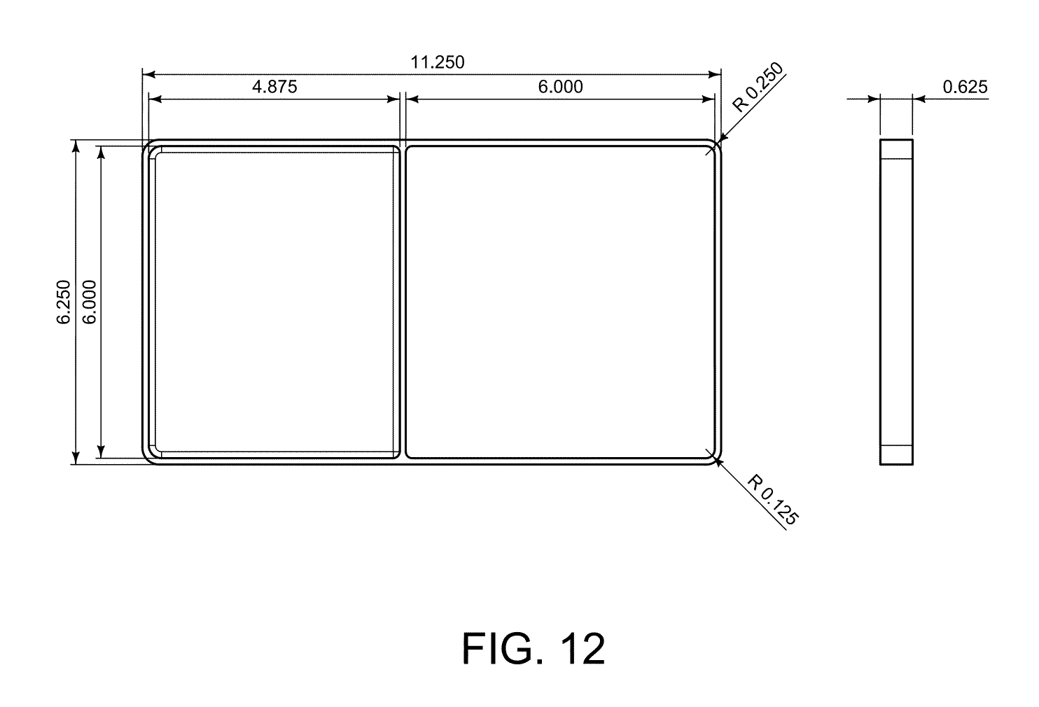

FIG. 12 is an engineering drawing representing a particular embodiment of a delivery tray such as delivery tray 118.

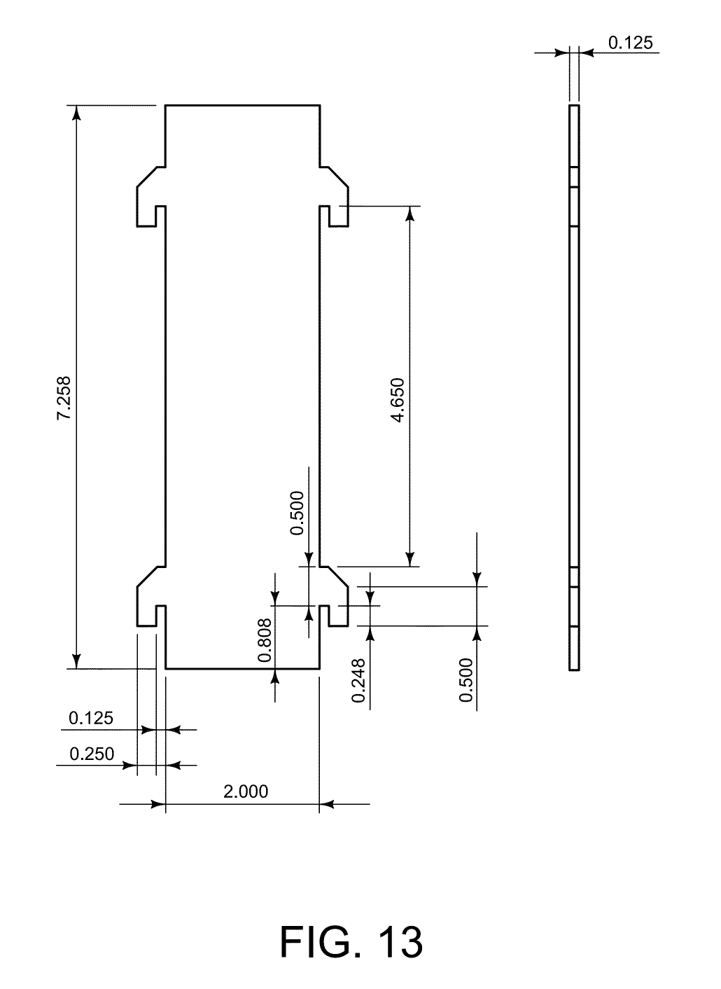

FIG. 13 is an engineering drawing representing a particular embodiment of a delivery passageway such as delivery passageway 310.

### Alternative Components of Interactive Unit

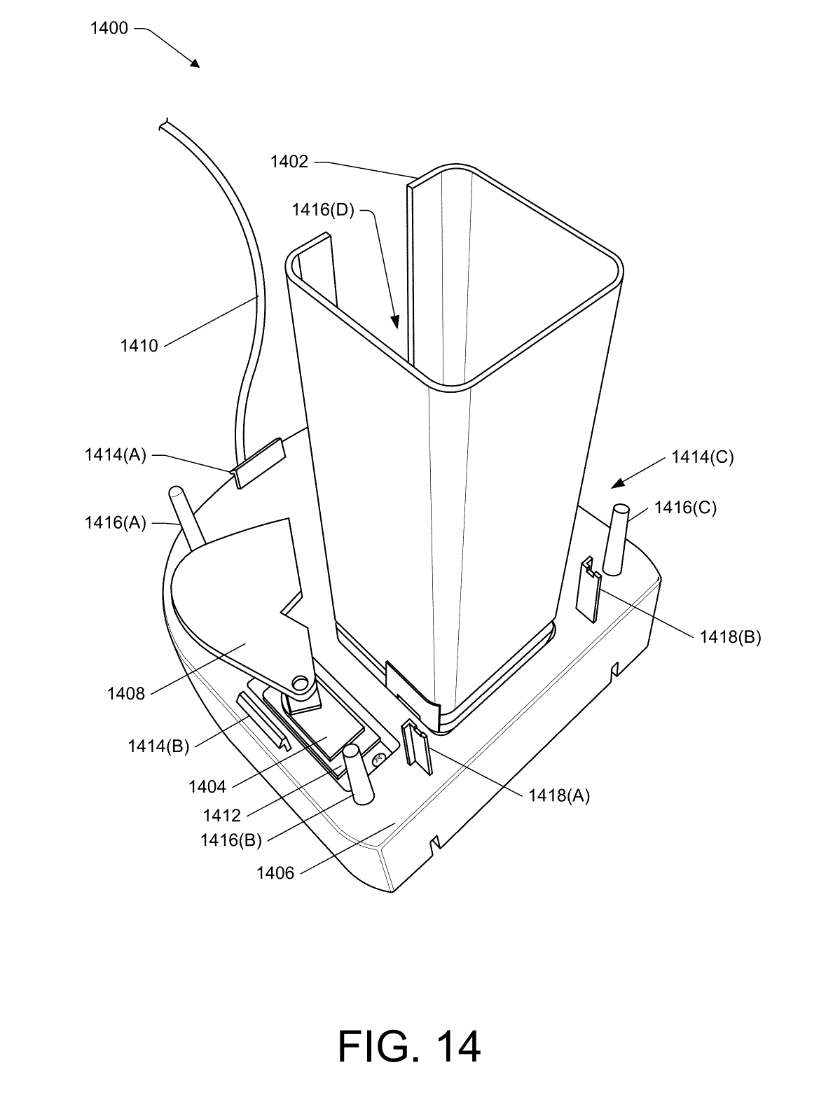

FIG. 14 is a perspective view of alternative components 1400 of the interactive unit of FIG. 1, FIG. 2 and/or FIG. 3). The components 1400 as shown in FIG. 14 can include a container 1402, which can be connected to a base such as base 1406. The container 1402 is configured to accept at least one unit of product. Similar to container 402 discussed above with regards to FIG. 4, in some embodiments, the container 1402 is an interchangeable container (e.g., interchangeable container 402A), arranged to be replaced by another container (e.g., interchangeable container 402B) of a different size or containing additional or alternate product. In some embodiments, the container 1402 can be removed in order to refill the container 1402 with at least one unit of product. The container can also be refilled while still connected to the IU.

In various embodiments, the user can remove the container 1402 and replace it with a container 1402 of a different size or containing additional or alternate product. In some embodiments, the container 1402 can be affixed within the housing, so that it is not removable. In embodiments with the container 1402 affixed, the container 1402 can be refilled via a first replaceable sleeve or cartridge (e.g., first replaceable sleeve 404).

The IU of FIG. 14 can include a motor 1404. In various embodiments, the motor 1404 is located in the base 1406. The motor 1404 can be operatively coupled to a mechanism for pushing 1408. While FIG. 14 illustrates the mechanism for pushing 1408 comprising a push-plate, the mechanism for pushing 1408 can include a turntable, push-rod, or another suitable mechanism. The motor 1404 is operatively coupled to the mechanism for pushing 1408, causing the mechanism for pushing 1408 to rotate about the motor 1404 in order to push a product out of the container 1402.

In some embodiments, the motor 1404 is an electric motor. The motor 1404 can be a servo motor, a rotary motor, a coreless motor, or another electric motor. In various embodiments, the motor 1404 can be coupled to a power source 1410. While FIG. 14 illustrates the power source 1410 comprising hard-wired electricity of either 110 V AC or 220 V AC, the power source may be a battery or batteries (e.g., rechargeable batteries). Similar to the motor 414 illustrated in FIG. 4, the motor 1404 is configured to receive an input signal from a communication device, such as communication device 202. Additionally, the motor can be configured to send an output signal. The motor can send and receive the input signal and the output signal via a communication system such as a wired and/or a wireless connection. The input signal and the output signal can be transmitted via a wire, a wireless network, a blue tooth connection, a near field communication connection, or a wifi direct connection. The input signal and the output signal can be processed through a microcontroller unit 1412 arranged in the base 1406. The microcontroller 1412 may be an Arduino microcontroller or another microcontroller capable of processing the input signal and the output signal.

In various embodiments, the motor 1404 receives an input signal from the communication device via the microcontroller unit 1412, and activates the mechanism for pushing 1408, causing the mechanism for pushing 1408 to track along a plane. For example, the mechanism for pushing 1408 may swing along a top planar surface of the base 1406. While tracking along the plane, the mechanism for pushing 1408 travels along a pre-determined path into an opening in container 1402. While traveling along the pre-determined path through the container 1402, the mechanism for pushing 1408 can contact at least one unit of product located within the container 1402. After contact with the at least one unit of product, the mechanism for pushing 1408 continues along the pre-determined path, continually applying pressure on the at least one unit of product. The mechanism for pushing 1408 thus forces the at least one unit of product through a hole in the container 1402, and exits the IU through the delivery opening 120. The at least one unit of product can then be available in the delivery tray 118 for consumption by a receiver.

The IU of FIG. 14 can include fastening mechanisms 1414(A), 1414(B), and 1414(C). In various embodiments, the fastening mechanisms 1414(A), 1414(B), and 1414(C) are attached to the base 1406. The fastening mechanisms 1414(A), 1414(B), and 1414(C) may couple a housing consistent with housings 102 and 502, as described above, to the base 1406. While FIG. 14 illustrates the fastening mechanisms 1414(A), 1414(B), and 1414(C) comprising latching mechanisms, the fastening mechanisms 1414(A), 1414(B), and 1414(C) can include threaded mechanisms, snap-fit mechanisms, interference-fit mechanisms, bayonet mechanisms, or another suitable mechanism.

The IU of FIG. 14 can include support members 1416(A), 1416(B), 1416(C), and 1416(D). In various embodiments, the support members 1416(A), 1416(B), and 1416(C), and 1416(D) are attached to the base 1406. The support members 1416(A), 1416(B), and 1416(C), and 1416(D) may support a housing consistent with housings 102 and 502, as described above, to the base 1406.

The IU of FIG. 14 can include structural members 1418(A) and 1418(B). In various embodiments, the structural members 1418(A) and 1418(B) are attached to the base 1406. The structural members 1418(A) and 1418(B) may couple with a delivery opening consistent with delivery opening 120 described above. For example, structural members 1418(A) and 1418(B) may couple with swinging door of a delivery opening.

### EXAMPLE CLAUSES

A. A device comprising: a housing comprising: at least one channel configured to hold a first clamp, the first clamp being selectively moveable in the at least one channel; a second clamp; the first clamp and the second clamp being configured to accept a communications device, the communication device being operatively couplable to a network; a delivery opening; a container affixable to the housing, the container being sized to hold at least one product; and a motor operatively couplable to the network and a power source, the motor being configured to cause the at least one product to be dispensed from the container through the delivery opening.

B. A device as paragraph A recites, wherein the channel has a length of at least about ½ of an inch and at most about eighteen inches.

C. A device as paragraph A or B recites, wherein the channel has a width of at least about ⅛ of an inch and at most about ¾ of an inch.

D. A device as any one of paragraphs A through C recites, wherein the at least one channel is configured substantially vertically, and the first clamp is configured substantially horizontally.

E. A device as any one of paragraphs A through C recites, wherein the at least one channel is configured substantially horizontally, and the first clamp is configured substantially vertically.

F. A device as any one of paragraphs A through E recites, wherein the communication device includes at least one personal computing device comprising a telephone, a smart phone, a tablet computer, a hybrid computer, a docking tablet, a two-in-one device, a three-in-one device, a personal digital assistant, a television, a desktop computer, and/or a computer.

G. A device as any one of paragraphs A through F recites, wherein the container comprises a first interchangeable container, the first interchangeable container being removably disposed in the housing to allow a user to remove the first interchangeable container and replace it with a second interchangeable container.

H. A device as paragraph G recites, wherein the second interchangeable container is configured to hold product of a different size than the first interchangeable container.

I. A device as any one of paragraphs A through H recites, wherein the motor is operatively coupled to a substantially disk-shaped body, causing the substantially disk-shaped body to rotate about the motor in order to push the at least one product out of the container.

J. A device as any one of paragraphs A through H recites, wherein the motor is operatively coupled to a push-rod, the push-rod extending upon activation of the motor to push the at least one product out of the container.

K. A device as any one of paragraphs A through H recites, wherein the motor is operatively coupled to a push-plate, causing the push-plate to rotate about the motor in order to push the at least one product out of the container.

L. A device as any one of paragraphs A through K recites, wherein the motor is a servo motor including a microcontroller unit.

M. A device as any one of paragraphs A through L recites, wherein the motor is selectively operable by a second communication device.

N. A device as any one of paragraphs A through M recites, wherein the motor is selectively operable by the communication device via at least one of a network connection, a blue tooth connection, a near field communication connection, or a wifi direct connection.

O. The device as any one of paragraphs A through N recite, wherein the power source includes batteries.

P. A device as any one of paragraphs A through O recites, wherein the power source includes hard-wired electricity of either 110 V AC or 220 V AC.

Q. A device as any one of paragraphs A through P recites, further comprising a delivery passageway connecting the container with the delivery opening.

R. A device as paragraph Q recites, wherein the delivery passageway has a dry coefficient of friction of at least about 0.1 and at most about 0.5.

S. A method comprising: receiving an incoming first signal by a communication device; sending a second signal from the communication device to a motor; responsive to receiving the second signal, the motor activating a mechanism for pushing; and releasing, via the mechanism for pushing, at least one unit of a plurality of units of product from a container.

T. A method as paragraph S recites, wherein the motor is configured to receive a signal transmitted via at least one of a network, a blue tooth communication connection, a near field communication connection, or a wifi direct connection.

U. A method as paragraphs S or T recite, the container comprising a first interchangeable sleeve configured to fit within the container; and the method further comprising replacing the first interchangeable sleeve with a second interchangeable sleeve, the second interchangeable sleeve configured to fit within the container and hold product of a different size than the first interchangeable sleeve.

V. A method as any one of paragraphs S through U recites, further comprising: releasing a first clamp, the first clamp working in conjunction with a second clamp to hold the communication device; moving the first clamp;

releasing the communication device; replacing the communication device with another communication device; moving the first clamp to hold the another communication device; and securing the first clamp in place to seat the another communication device.

W. A system comprising: an application loadable on at least a first communication device and a second communication device; a motor operatively coupled to the first communication device, the motor configured to: receive an input via the application from the second communication device; and responsive to receiving the input, activate a mechanism for pushing, wherein the mechanism for pushing causes at least one unit of product to be dispensed from a container.

X. A system as paragraph W recites, wherein the motor is configured to receive a signal transmitted via at least one of a network, a blue tooth communication connection, a near field communication connection, or a wifi direct connection.

Y. A system as paragraph W or X recites, the container comprising a first interchangeable sleeve configured to fit within the container; and the method further comprising replacing the first interchangeable sleeve with a second interchangeable sleeve, the second interchangeable sleeve configured to fit within the container and hold product of a different size than the first interchangeable sleeve.

Z. A system as any one of paragraphs W through Y recites, further comprising: releasing a first clamp, the first clamp working in conjunction with a second clamp to hold the communication device; moving the first clamp; releasing the communication device; replacing the communication device with another communication device; moving the first clamp to hold the another communication device; and securing the first clamp in place to seat the another communication device.

AA. A system comprising: an application loadable on at least a first communication device and a second communication device; a motor operatively coupled to the first communication device, the motor configured to: receive an input via the application from the second communication device; and responsive to receiving the input, activate a mechanism for pushing, wherein the mechanism for pushing causes at least one unit of product to be dispensed from a container.

BB. A system as paragraph AA recites, the motor configured to receive the input via the application from the second communication device through the first communication device.

CC. A system as paragraph AA or paragraph BB recites, wherein the container comprises a first sleeve configured to fit within the container that is removable and replaceable with a second sleeve, the second sleeve configured to dispense at least one unit of product of a different size than the at least one unit of product from the first sleeve.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

In some embodiments, one or more of the methods and processes described above may be embodied in, and fully automated via, software code modules executed by one or more computers or processors such as computers or processors including end user device 606 and/or communications device 608. The code modules can be stored in any type of computer-readable storage medium or other computer storage device. Some or all of the methods can alternatively be embodied in specialized computer hardware.

Conditional language such as, among others, “can,” “could,” “might” or “may,” unless specifically stated otherwise, are otherwise understood within the context as used in general to present that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the embodiments described herein in which elements or functions may be deleted, or executed out of order from that shown or discussed, including substantially synchronously or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A device comprising:
a housing comprising:
at least one channel configured to hold a first clamp, the first clamp being selectively moveable in the at least one channel;
a second clamp;
the first clamp and the second clamp being configured to accept a communications device, the communication device being operatively couplable to a network;
a delivery opening;
a container affixable to the housing, the container being sized to hold at least one product; and
a motor operatively couplable to the network and a power source, the motor being configured to cause the at least one product to be dispensed from the container through the delivery opening.

2. A device as claim 1 recites, wherein the channel has a length of at least about ½ of an inch and at most about eighteen inches and/or the channel has a width of at least about ⅛ of an inch and at most about ¾ of an inch.

3. A device as claim 1 recites, wherein the at least one channel is configured substantially vertically, and the first clamp is configured substantially horizontally or the at least one channel is configured substantially horizontally, and the first clamp is configured substantially vertically.

4. A device as claim 1 recites, wherein the communication device includes at least one personal computing device comprising a telephone, a smart phone, a tablet computer, a hybrid computer, a docking tablet, a two-in-one device, a three-in-one device, a personal digital assistant, a television, a desktop computer, and/or a computer.

5. A device as claim 1 recites, wherein the container comprises a first interchangeable container, the first interchangeable container being removably disposed in the housing to allow a user to remove the first interchangeable container and replace it with a second interchangeable container.

6. A device as claim 1 recites, wherein:
the motor is operatively coupled to a substantially disk-shaped body, causing the substantially disk-shaped body to rotate about the motor in order to push the at least one product out of the container;
the motor is operatively coupled to a push-rod, the push-rod extending upon activation of the motor to push the at least one product out of the container; or
the motor is operatively coupled to a push-plate, causing the push-plate to rotate about the motor in order to push the at least one product out of the container.

7. A device as claim 1 recites, wherein the motor is a servo motor including a microcontroller unit.

8. A device as claim 1 recites, wherein the motor is selectively operable by a second communication device.

9. A device as claim 1 recites, wherein the motor is selectively operable by the communication device via at least one of a network connection, a blue tooth connection, a near field communication connection, or a wifi direct connection.

10. A device as claim 1 recites, wherein the power source includes batteries and/or the power source includes hard-wired electricity of either 110 V AC or 220 V AC.

11. A method comprising:
receiving an incoming first signal by a communication device;
sending a second signal from the communication device to a motor;
responsive to receiving the second signal, the motor activating a mechanism for pushing; and
releasing, via the mechanism for pushing, at least one unit of a plurality of units of product from a container.

12. A method as claim 11 recites, wherein the motor is configured to receive a signal transmitted via at least one of a network, a blue tooth communication connection, a near field communication connection, or a wifi direct connection.

13. A method as claim 11 recites, the container comprising a first interchangeable sleeve configured to fit within the container; and the method further comprising replacing the first interchangeable sleeve with a second interchangeable sleeve, the second interchangeable sleeve configured to fit within the container and hold product of a different size than the first interchangeable sleeve.

14. A system comprising:
an application loadable on at least a first communication device and a second communication device;
a motor operatively coupled to the first communication device, the motor configured to:
receive an input via the application from the second communication device; and
responsive to receiving the input, activate a mechanism for pushing, wherein the mechanism for pushing causes at least one unit of product to be dispensed from a container.

15. A system as claim 14 recites, the motor configured to receive the input via the application from the second communication device through the first communication device.

16. A system as claim 14 recites, wherein the container comprises a first sleeve configured to fit within the container that is removable and replaceable with a second sleeve, the second sleeve configured to dispense at least one unit of product of a different size than the at least one unit of product from the first sleeve.
